(19) United States
(12) Patent Application Publication
(10) Pub. No.: US 2024/0219911 A1
(43) Pub. Date: Jul. 4, 2024

(54) ATTENTION BASED SENSOR PROCESSING FOR A REMOTELY PILOTED VEHICLE

(71) Applicant: Urban Robotics, Inc., Las Vegas, NV (US)

(72) Inventors: William Joseph REEVES, Silverthorne, CO (US); Anand NANDAKUMAR RAGHAV, Las Vegas, NV (US)

(21) Appl. No.: 18/530,426

(22) Filed: Dec. 6, 2023

Related U.S. Application Data
(60) Provisional application No. 63/386,284, filed on Dec. 6, 2022.

(51) Int. Cl. G05D 1/224; G05D 101/00; G06F 3/01

(52) U.S. Cl. CPC G05D 1/2247; G06F 3/013; G05D 2101/22

(57) ABSTRACT

Processing sensor data from a plurality of sensors monitoring an exterior environment of a remotely controlled vehicle. The sensors generate a corresponding respective plurality of sensor data feeds. A compositor for combining the plurality of sensor data feeds into a composite data stream is provided. A remote pilot terminal is operative to receive the composite data stream and render a representation of the exterior environment of the remotely controlled vehicle to a remote pilot. A pilot monitor determines an area of focus of the remote pilot, and the area of focus is provided to the compositor for use in differentiating the plurality of data feeds in the composite data stream. The representation of the exterior environment at the remote operator terminal is based on the area of focus of the remote pilot.

### BACKGROUND

Advances in technology have enabled alternative paradigms in vehicle control. For example, vehicles may now include various levels of autonomous control. However, full autonomous control continues to present difficulties in certain contexts and scenarios. As such, remote control of vehicles has been proposed to provide for efficiency in the operation of vehicle, while maintaining human control over vehicles, albeit from humans remote to the vehicle.

Remote control of the vehicle relies on relay of sensor information from a remotely controlled vehicle to a remote pilot of the vehicle. In turn, a remote pilot may provide inputs for generation of commands that may be returned to the vehicle for execution of the commands at the remotely controlled vehicle. In this regard, remote control of a vehicle may rely on communication of data between the remotely controlled vehicle and a remote pilot terminal. The efficiency at which such data may be transmitted may be important to provide sufficient connectivity between the remote pilot and the remotely operated vehicle to allow for safe operation of the remotely operated vehicle.

### SUMMARY

In some aspects, the techniques described herein relate to a system for processing sensor data at a remotely controlled vehicle, including: a plurality of sensors for monitoring an exterior environment of the remotely controlled vehicle to generate a corresponding respective plurality of sensor data feeds. Adjacent pairs of the plurality of sensors may include an at least partially overlapping field of view. The system includes a compositor for combining the plurality of sensor data feeds into a composite data stream, a remote pilot terminal operative to receive the composite data stream and render a representation of the exterior environment of the remotely controlled vehicle to a remote pilot, and a pilot monitor for determining an area of focus of the remote pilot. The area of focus is provided to the compositor for use in differentiating the plurality of data feeds in the composite data stream, and the representation of the exterior environment at the remote operator terminal is based on the area of focus of the remote pilot.

In some aspects, the techniques described herein relate to a method for processing sensor data at a remotely controlled vehicle, including: determining an area of focus of a remote pilot of the remotely controlled vehicle; monitoring an exterior environment relative to the remotely controlled vehicle with a plurality of sensors to generate a corresponding respective plurality of sensor data feeds, wherein adjacent pairs of the plurality of sensors including an at least partially overlapping field of view; combining the plurality of sensor data feeds into a composite data stream, wherein the composite data stream differentiates the plurality of sensor data feeds in the composite data stream based on the area of focus of the remote pilot; and rendering a representation of the exterior environment at a remote pilot terminal based on the area of focus of the remote pilot.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system that facilitates remote control of a remotely controlled vehicle.

FIG. 2 illustrates an example of a sensor arrangement of a remotely operated vehicle.

FIG. 3 illustrates an example sensor arrangement of a remotely controlled vehicle that may provide a continuous field of view about the remotely controlled vehicle.

FIG. 4 illustrates an example system for facilitating an arrangement for a remotely piloted vehicle.

FIG. 5 illustrates an example representation of a composite data feed comprising a plurality of sensor data feeds.

FIG. 6 illustrates an example representation of a composite data feed in which sensor data in an area of focus is treated differently than sensor data outside the area of focus.

FIG. 7 illustrates an example representation of a composite data feed in which an area of focus has moved.

FIG. 8 illustrates an example process according to the present disclosure.

FIG. 9 illustrates an example computing device capable of executing certain aspects of the present disclosure.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

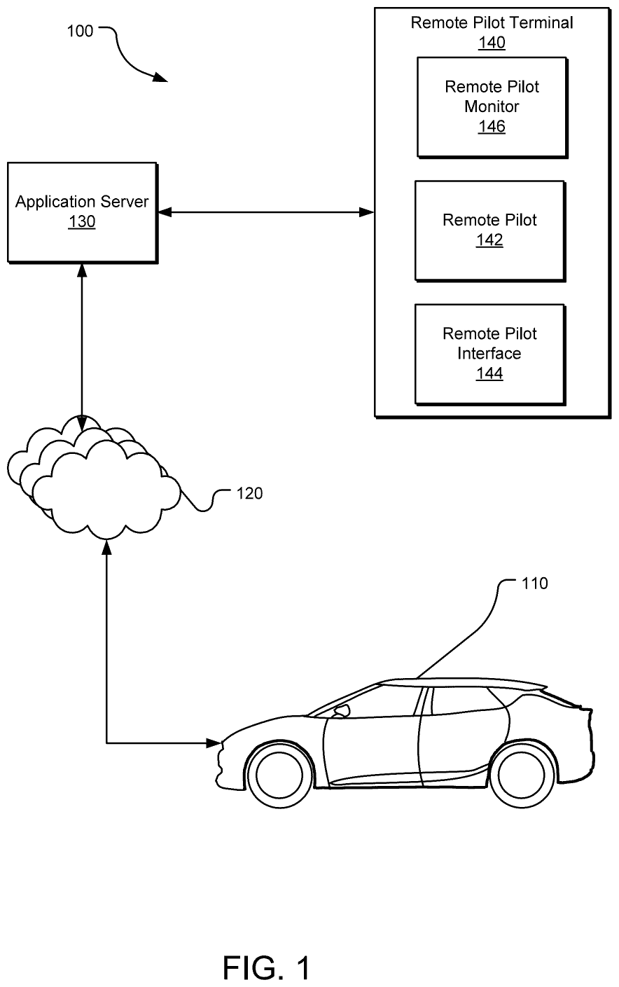

FIG. 1 illustrates an example system 100 that facilitates remote control of a remotely controlled vehicle 110. The remotely controlled vehicle 110 may be in operative connection with a remote pilot terminal 140 via a network 120. The network 120 may comprise a plurality of networks over which the remotely controlled vehicle 110 may communicate. Providing capability to communicate over a plurality of networks may allow for redundancy in the event of a problem with one of the networks or optimization of communication using a network 120 having the highest quality as the remotely controlled vehicle 110 operates through an environment.

An application server 130 may be provided that assists in orchestrating communication between the remotely controlled vehicle 110 and the remote pilot terminal 140. For instance, the application server 130 may coordinate connection to a remote pilot terminal 140 as needed (e.g., when the remotely controlled vehicle 110 transitions from autonomous or local control to remote control). The application server 130 may also provide various assistance or aides to the remotely controlled vehicle 110 or the remote pilot terminal 140 to help facilitate control of the remotely controlled vehicle 110 by a remote pilot 142 from the remote pilot terminal 140.

The remote pilot terminal 140 may include a remote pilot interface 144. The remote pilot interface 144 may receive inputs from the remote pilot 142 for control of the remotely controlled vehicle 110. For example, the remote pilot interface 144 may include appropriate displays and input devices to allow the remote pilot 142 to perceive displayed sensor data from the remotely controlled vehicle 110 and to input control commands to the remote pilot interface 144. The remote pilot interface 144 may include any appropriate display(s) including monitors, monitor arrays, augmented reality displays, virtual reality displays, or the like. The input devices may include controls similar to those provided locally at the remotely controlled vehicle 110 including a steering wheel, accelerator pedal, brake pedal, drive selector, or other controls (e.g., wiper controls, headlight controls, etc.). Thus, the remote pilot 142 may be presented with an environment that mimics an interior of the remotely controlled vehicle 110 to help provide familiarity in remotely controlling the remotely controlled vehicle 110.

The remote pilot terminal 140 may also include a remote pilot monitor 146. The remote pilot monitor 146 may monitor a position of the remote pilot 142 to determine an area of focus of the remote pilot 142. The area of focus of the remote pilot 142 may be an area in which the remote pilot 142 has directed their attention. For instance, the remote pilot monitor 146 may monitor a head position of the remote pilot 142 to determine a direction that the remote pilot 142 is looking. Additionally or alternatively, the remote pilot monitor 146 may include an eye position monitor that also allows determination of a direction in which the remote pilot 142 is looking. The remote pilot monitor 146 may include any appropriate sensor including wearable sensors that monitor head position and/or eye position of the remote pilot 142 and/or external monitors that observe the remote pilot 142.

As will be described in greater detail below, the remote pilot monitor 146 may be used to determine an area of focus of the remote pilot 142. This may beneficially allow for processing of sensor data feeds at the remotely controlled vehicle 110. For example, upon determination of an area of focus of the remote pilot 142, sensor data corresponding to an observed exterior environment of the remotely controlled vehicle 110 within the area of focus of the remote pilot 142 may be prioritized to provide higher resolution or other processing to preserve a higher level of detail in the area of focus when rendered for presentation to the remote pilot 142 via a display device of the remote pilot interface 144. By prioritizing sensor data corresponding to the area of focus, data transmission and processing requirements for the sensor data from the remotely controlled vehicle 110 may be reduced, thus facilitating reduced network bandwidth usage, lower latency in transmission of sensor data to the remote pilot terminal 140, or other benefits.

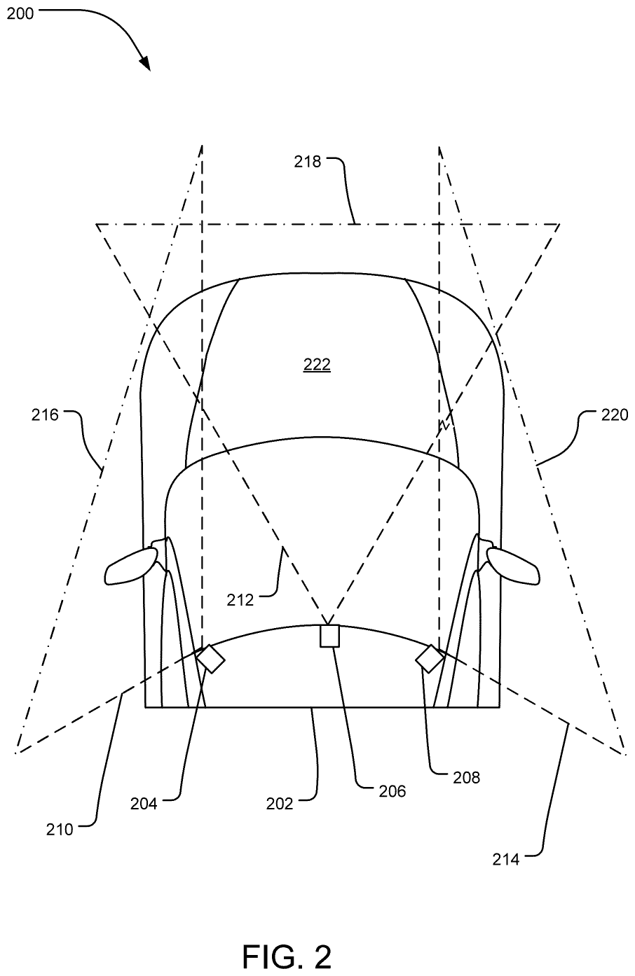

With further reference to FIG. 2, an example of a sensor arrangement 200 of a remotely operated vehicle 202 is shown. The remotely operated vehicle 202 may be equipped with a plurality of sensors capable of monitoring an exterior environment of the remotely operated vehicle 202. For example, the sensors may include a first camera 206, a second camera 208, and a third camera 204. The first camera 206 may be a front-facing camera mounted to generate a forward view 218 from a forward field 212 of the first camera 206. The second camera 208 may be a right-facing camera mounted to generate a right view 220 from a right field 214 of the second camera 208. The third camera 204 may be a left-facing camera mounted to generate a left view 216 from a left field 210 of the third camera 204.

Adjacent sensors may have at least partially overlapping fields of view. This may allow for compositing of the sensor data feeds from the plurality of sensors into a composite data feed as described in greater detail below. For example, the third camera 204 may have a left field 210 that partially overlaps the forward field 212 of the first camera 206. The overlapping portion of the left field 210 and the forward field 212 may include at least a portion of a hood 222 of the remotely operated vehicle 202. In addition, the forward field 212 may ate least partially overlap the right field 214. The overlapping portion of the forward field 212 and the right field 214 may include at least a portion of the hood 222. By including the hood 222 in the overlapping portions of the fields of view, the hood 222 may provide a contextual reference to a remote pilot and/or assist in combining the data streams from the respective sensors by providing a common reference contained in data streams from adjacent sensors.

The arrangement shown in FIG. 2 illustrates that the plurality of sensors may provide a continuous field of view around at least a portion of the remotely operated vehicle 202. In the illustrated example, a field of view extending for greater than 180 degrees may be established by the plurality of sensors. In turn, the sensor data (or a composite data feed comprising a combination of the plurality of sensor data feeds) may allow for presentation of a large field of view to a remote pilot to assist in operation of the remotely operated vehicle 202.

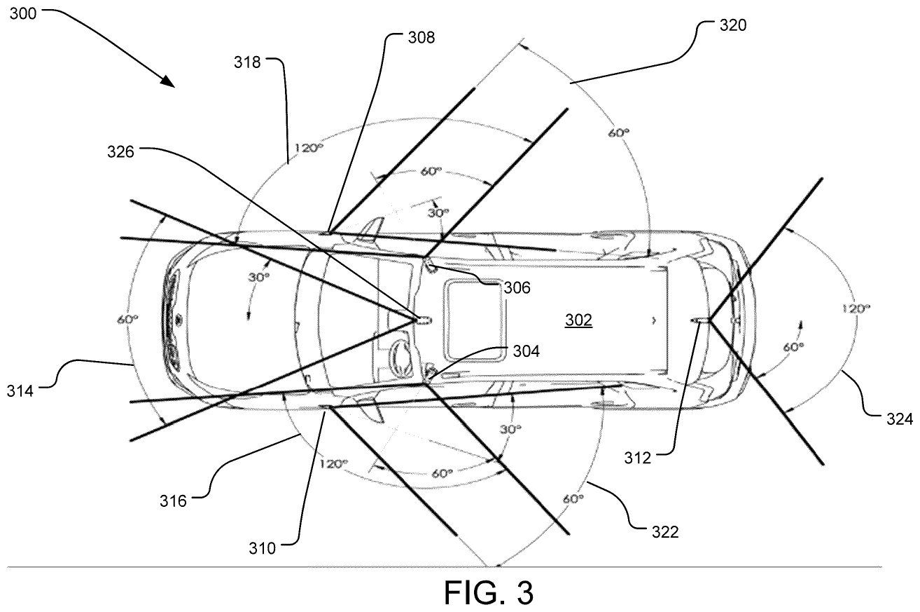

FIG. 3 provides an example sensor arrangement 300 of a remotely controlled vehicle 302 that may provide a continuous field of view about the remotely controlled vehicle 302. In this regard, the remotely controlled vehicle 302 may include a front facing camera 326 to generate a front view 314, a left forward facing camera 304 to generate a left forward view 316, and a right forward facing camera 306 to generate a right forward view 318. The front facing camera 326, left forward facing camera 304, and right forward facing camera 306 may provide a similar arrangement as that shown in FIG. 2. In addition, the remotely controlled vehicle 302 may include a right reverse facing camera 308 to generate a right reverse view 322, a left reverse facing camera 310 to generate a left reverse view 320, and a rear camera 312 to generate a rear view 324. As may be appreciated, the front facing camera 326, left forward facing camera 304, right forward facing camera 306, right reverse facing camera 308, left reverse facing camera 310, and rear camera 312 may provide a substantially continuous combined field of view about the entirety of the remotely controlled vehicle 302.

While such an expansive field of view may be beneficial to allow a remote pilot to fully observe the surroundings of the remotely controlled vehicle 302, the combined field of view may require significant network and computational resources to communicate the sensor data between the remotely controlled vehicle 302 and a remote pilot. In turn, the present disclosure generally contemplates monitoring the remote pilot to allow for determination of an area of focus of the remote pilot relative to the exterior environment of the remotely controlled vehicle 302. In turn, sensor data corresponding to the area of focus may be prioritized to allow for relatively higher quality data in the area of focus to be presented to the remote pilot while also reducing the total amount of data that is communicated between the remotely controlled vehicle 302 and the remote pilot.

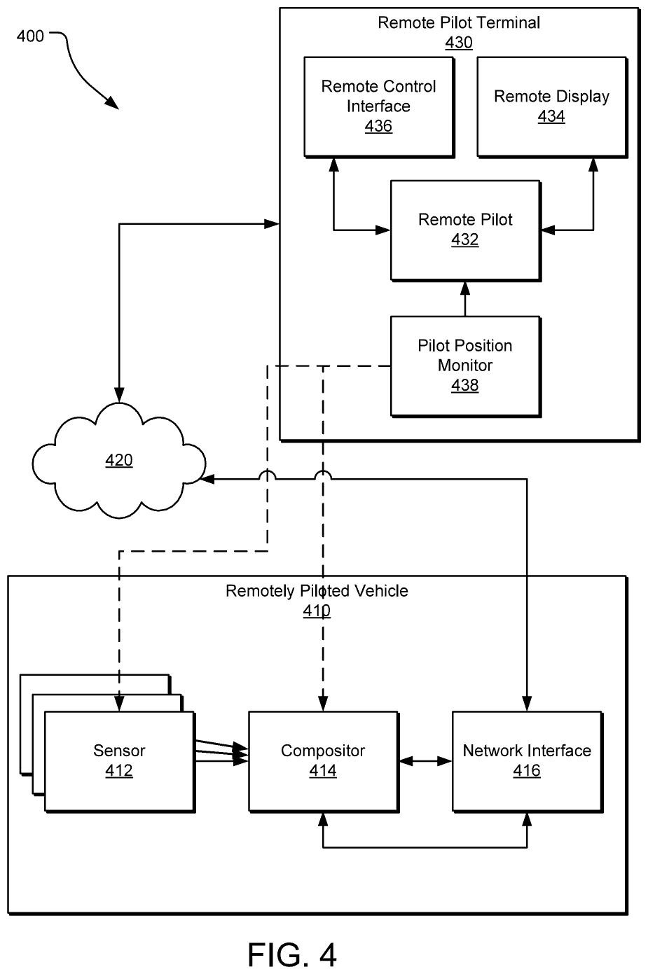

FIG. 4 illustrates a system 400 for facilitating such an arrangement for a remotely piloted vehicle 410. The remotely piloted vehicle 410 may include a plurality of sensors 412. The sensors 412 may include a plurality of cameras as shown in FIG. 2 or FIG. 3, or may include other types and/or combinations of sensors. In any regard, each sensor of the plurality of sensors 412 may generate a corresponding respective sensor data feed. That is, a plurality of sensor data feeds may be generated, in which each respective one of the plurality of sensor data feeds is provided by a respective one of the sensors 412. A given sensor may provide a plurality of data feeds as well.

In any regard, a compositor 414 may be operative to combine the plurality of sensor data feeds from the sensors 412 into a composite data stream. The compositor 414 may stitch together the plurality of data feeds to provide a continuous representation of the sensor data. In this regard, common references such as the hood or other portion of the remotely piloted vehicle 410 may be presented in a relatively seamless fashion in a resulting composite data feed. The composite data feed may provide a single stream of data to a network interface 416 for communication over a network 420. By communicating the composite data stream from the network interface 416, simplified and optimized network communication may be realized. For example, as discussed in U.S. Provisional Patent Application No. 63/373,994 filed on Aug. 30, 2022 entitled “DYNAMIC MANAGEMENT OF VEHICLE SENSOR DATA BASED ON FORECAST NETWORK CONDITIONS,” the entirety of which is incorporated by reference herein, use of a composite data stream may allow for more efficient processing to apply compression to the composite data stream based on predicted network conditions and/or may allow for simplified monitoring of situations in which the network may not be sufficient to meet a threshold level of quality.

Accordingly, the network interface 416 may communicate the composite data stream to a remote pilot terminal 430 via the network 420. In turn, the composite data stream may be rendered on a remote display 434 such that the data from the sensors 412 are presented to a remote pilot 432 using the remote display 434. In this regard, the remote display 434 may present data from the composite data stream including data from more than one of the sensors 412. This may be particularly useful in the event that the remote display 434 includes a virtual reality display headset in which the remote pilot 432 may observe an expansive portion of the exterior environment represented in the composite data stream. As noted above, the remote pilot terminal 430 may also include a remote control interface 436 to allow the remote pilot 432 to input commands that may be relayed to the remotely piloted vehicle 410 for control of the remotely piloted vehicle 410.

The remote pilot terminal 430 may also include a pilot position monitor 438. As noted above, the pilot position monitor 438 may monitor a head position, eye position, or some other characteristic of the remote pilot 432 to determine an area of focus of the remote pilot 432. That is, the pilot position monitor 438 may determine a direction in which the remote pilot 432 is looking in relation to the representation of the exterior environment of the remotely piloted vehicle 410 based on sensor data captured by the sensors 412.

The pilot position monitor 438 may be able to provide information regarding the area of focus of the remote pilot 432 to the sensors 412 and/or compositor 414. While shown as operative connections via dotted lines in FIG. 4, this information may be communicated via the network 420 (e.g., in combination with command data from the remote control interface 436).

The information regarding the area of focus may be operative to control one or more of the sensors 412. For example, at least one of the sensors 412 may be physically moveable relative to the remotely piloted vehicle 410. As an example, a camera may be pivoted through a range of motion to allow for side to side and/or up and down movement of a field of view of the camera. As such, the camera may be moved in relation to the area of focus of the remote pilot 432. As an example, a front camera may be pivoted left if the area of focus of the remote pilot 432 moves to the left or may be pivoted right if the area of focus of the remote pilot 432 moves to the right.

The information regarding the area of focus may also be provided to the compositor 414. This may allow the compositor 414 to prioritize sensor data from the sensors 412 within the area of focus when generating the composite data stream. In this regard, data from a given sensor 412 or a selected portion of data from a given one or more sensor 412 may be processed at a different level than data falling outside the area of focus. For example, a bit rate for data within the area of focus may be increased to provide a lower latency, higher resolution, or other benefit in relation to the data outside the area of focus. In this regard, the total amount of data to be transmitted in the combined data feed may be reduced, while preserving higher quality for data in the area of focus.

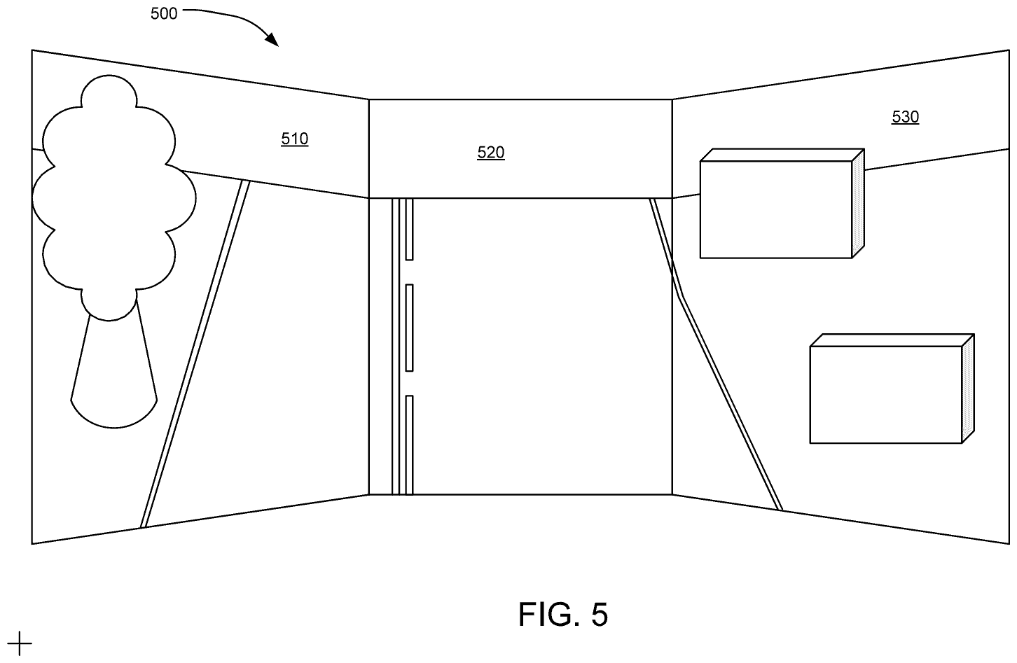

This concept is further illustrated in FIGS. 5-7. In FIG. 5, a representation 500 of a composite data feed as rendered for viewing by a remote pilot is illustrated. The representation 500 may correspond to a combination of sensor data from a first sensor to provide a left-facing view 510, sensor data from a second sensor to provide a center-facing view 520, and sensor data from a third sensor to provide a right-facing view 530. As described above, because adjacent ones of the sensors may have an at least partially overlapping field of view, the combination of sensors may be combined to provide a cohesive representation of an exterior environment using the left-facing view 510, center-facing view 520, and right-facing view 530 as shown. Also, while represented as distinct panels (e.g., which could be presented on one or more corresponding monitors or displays), the representation 500 may also be a representation of a virtual environment created using the left-facing view 510, center-facing view 520, and right-facing view 530. Thus, while represented as distinct panels, the representation 500 may be cohesively presented as a cohesive environment in a virtual reality device to a user.

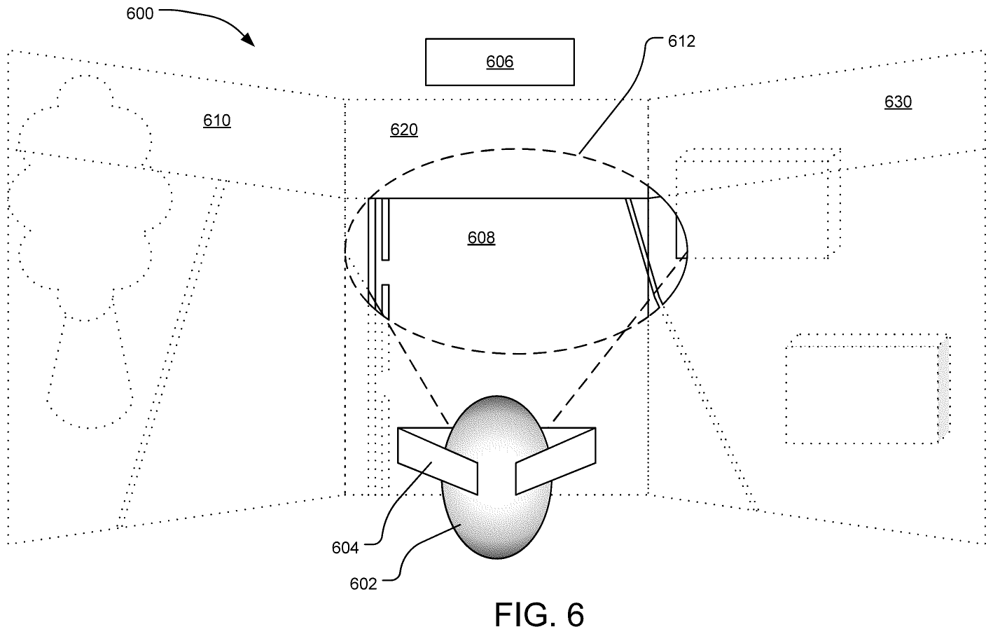

For example, with further reference to FIG. 6, a representation 600 that may correspond to the representation 500 is shown. A remote pilot 602 may wear a virtual reality headset 604 to present the representation 600 to the remote pilot 602. Like the representation 500, the representation 600 may include a combination of a left-facing view 610, center-facing view 620, and right-facing view 630 generated from corresponding sensors.

Also shown in FIG. 6 is an area of focus 612. The area of focus 612 may be determined by monitoring a position of the remote pilot 602 such as a position of the head and/or eyes of the remote pilot 602. This monitoring may be provided by the virtual reality headset 604. Additionally or alternatively, a remote position sensor 606 may be provided to determine a position of the remote pilot 602. In any regard, as shown in FIG. 6, the sensor data 608 within the area of focus 612 may be presented in a different manner than data outside the area of focus 612. This is illustrated in FIG. 6 as the representation 600 outside the area of focus 612 being shown in broken lines. Thus, the broken lines outside the area of focus 612 may illustrate that this data is rendered at a lower quality or resolution than the sensor data 608 within the area of focus 612. This discrepancy may be reflected in a higher bit rate for the sensor data 608 within the area of focus 612.

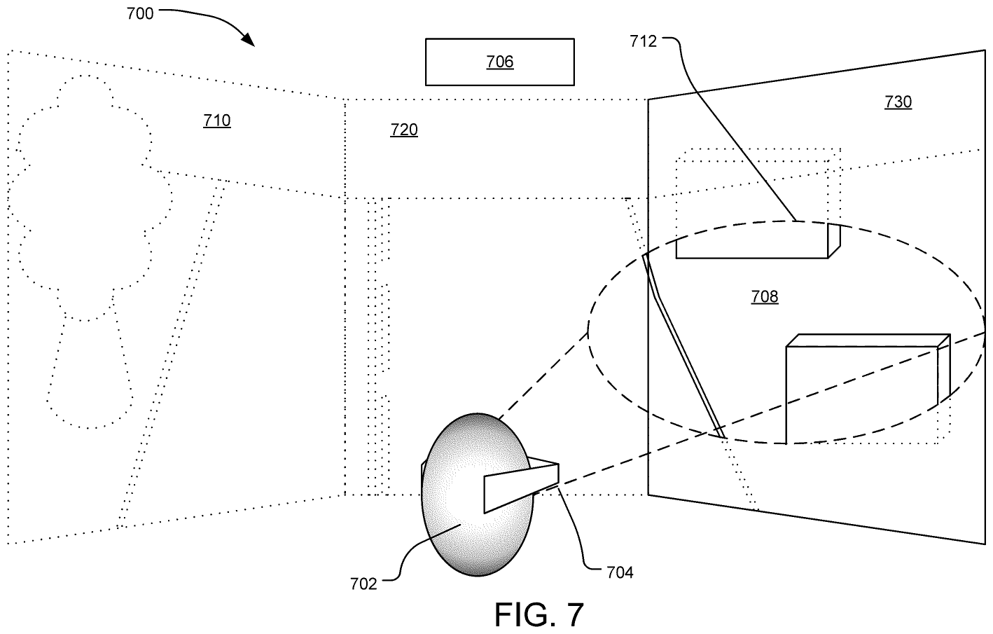

FIG. 7 illustrates another representation 700 of a combined data feed that may be presented to a remote pilot 702 wearing a virtual reality device 704. The representation 700 may include a left-facing view 710, center-facing view 720, and right-facing view 730. In this regard, the representation 700 may correspond to the representation 600. However, the remote pilot 702 may have changed a position such that an area of focus 712 is changed in relation to the representation 700. As such, as the area of focus 712 may be changed, the sensor data 708 included in the area of focus 712 may also change such that a compositor updates the sensor data 708 to which a higher data rate is applied. The change in position of the remote pilot 702 may be detected by the virtual reality device 704 or a remote position sensor 706.

Also, FIG. 7 illustrates that the area of focus 712 may extend to a plurality of the respective views. That is, the area of focus 712 may include some sensor data in the center-facing view 720 as well as sensor data in the right-facing view 730. In this regard, it should be understood that the compositor may be capable of applying differential data processing to sensor data within a given field of view. That is, the sensor data 708 that is prioritized or presented at a higher quality as compared to sensor data outside the area of focus 712 may include a portion of sensor data from the center-facing view 720 as well as a portion of sensor data from the right-facing view 730.

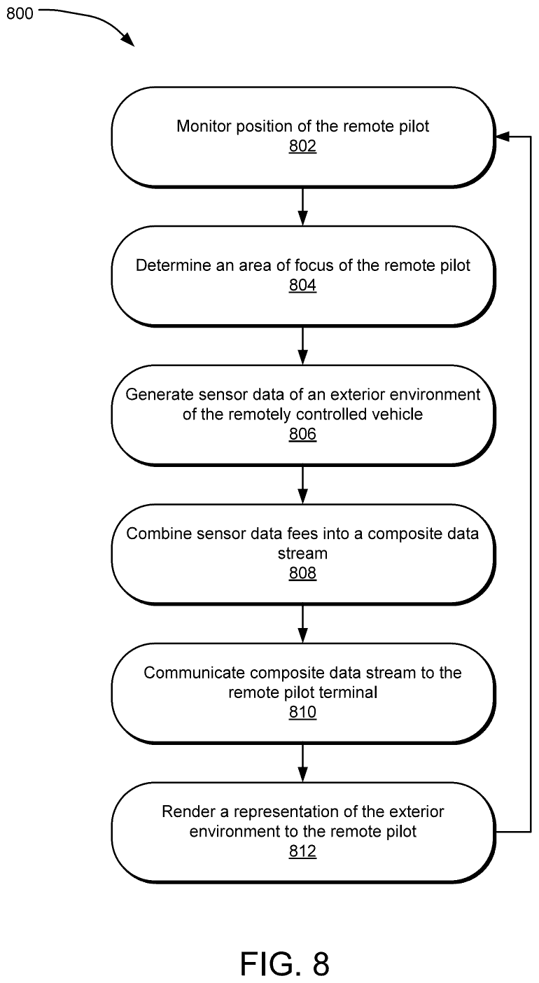

FIG. 8 illustrates an example process 800 according to the present disclosure. The process 800 includes a monitoring operation 802 in which a position of a remote pilot is monitored at a remote pilot terminal. As noted above, the monitoring operation 802 may be performed by one or more devices or sensors at the remote pilot terminal. For instance, a head position of the remote pilot and/or an eye position of the remote pilot may be determined by worn or remote sensors.

In any regard, a determining operation 804 may generate an area of focus based on the monitoring operation 802. That is, the area of focus of the remote pilot may be at least in part determined in the determining operation 804 based on data of the position of the remote pilot obtained in the monitoring operation 802.

In turn, the process 800 may include a data generating operation 806 in which one or more sensors collect data regarding an exterior environment of a remotely controlled vehicle. The data generating operation 806 may include generating sensor data feeds from a plurality of sensors at the remote vehicle. In an example, these sensors may include video cameras such that the data generating operation 806 may include obtaining video information regarding an exterior environment of the remotely controlled vehicle.

The process 800 further includes a combining operation 808 that combines the sensor data feeds obtained in the data generating operation 806 to generate a composite data stream. In this regard, the combining operation 808 may generate a single stream of data that includes the composite data feed (e.g., as generated by a compositor at the remotely controlled vehicle). Specifically, the combining operation 808 may include applying different bit rates to different respective portions of sensor data obtained in the data generating operation 806 based on the area of focus of the remote pilot from the determining operation 804 as described above in relation to FIGS. 6 and 7.

The process 800 also includes a communicating operation 810 in which the composite data stream is sent to a remote pilot terminal. In turn, a rendering operation 812 renders the composite data stream representative of the exterior environment to the remote pilot. Because the sensor data in the composite data stream within the area of focus may be prioritized, the rendering operation 812 may present the sensor data in the area of focus of the remote pilot at a higher quality than data outside the area of focus. As can be appreciated the process 800 is iterative such that the monitoring operation 802 is performed in a continual loop in relation to the rendering operation 812. In this regard, as new composite data stream data is rendered and presented to the remote pilot, the remote pilot may react and move an area of focus. This movement may be monitored in the monitoring operation 802 such that a new area of focus is determined in the determining operation 804. As such, the combining operation 808 may be conducted such that the sensor data related to the new area of focus may be processed differently to provide a higher quality image in the rendering operation 812.

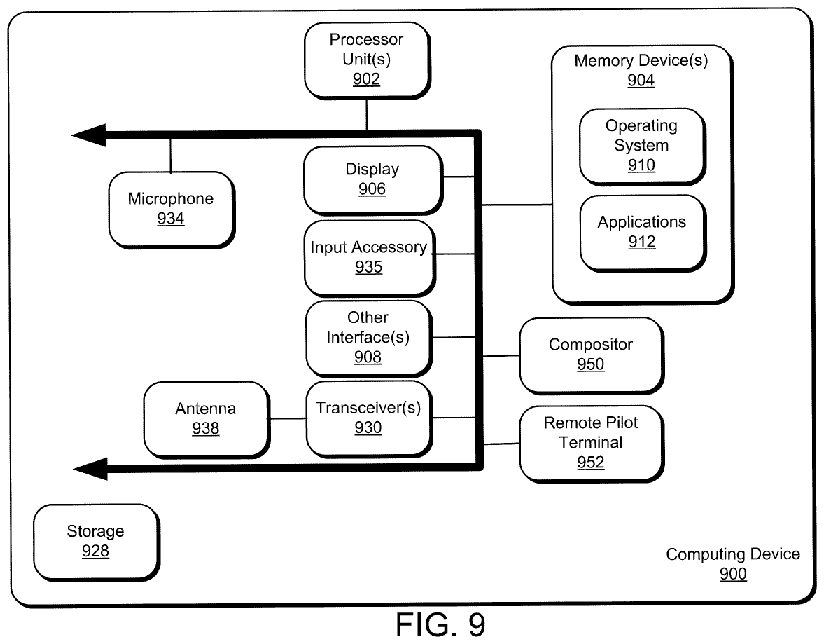

FIG. 9 illustrates an example schematic of a computing device 900 suitable for implementing aspects of the disclosed technology including a compositor 950, a remote pilot terminal 952, or other device as described above. The computing device 900 includes one or more processor unit(s) 902, memory 904, a display 906, and other interfaces 908 (e.g., buttons). The memory 904 generally includes both volatile memory (e.g., RAM) and non-volatile memory (e.g., flash memory). An operating system 910, such as the Microsoft Windows® operating system, the Apple macOS operating system, or the Linux operating system, resides in the memory 904 and is executed by the processor unit(s) 902, although it should be understood that other operating systems may be employed.

One or more applications 912 are loaded in the memory 904 and executed on the operating system 910 by the processor unit(s) 902. Applications 912 may receive input from various input local devices such as a microphone 934, input accessory 935 (e.g., keypad, mouse, stylus, touchpad, joystick, instrument mounted input, or the like). Additionally, the applications 912 may receive input from one or more remote devices such as remotely-located smart devices by communicating with such devices over a wired or wireless network using more communication transceivers 930 and an antenna 938 to provide network connectivity (e.g., a mobile phone network, Wi-Fi®, Bluetooth®). The computing device 900 may also include various other components, such as a positioning system (e.g., a global positioning satellite transceiver), one or more accelerometers, one or more cameras, an audio interface (e.g., the microphone 934, an audio amplifier and speaker and/or audio jack), and storage devices 928. Other configurations may also be employed.

In an example implementation, the computing device 900 comprises hardware and/or software embodied by instructions stored in the memory 904 and/or the storage devices 928 and processed by the processor unit(s) 902. The memory 904 may be the memory of a host device or of an accessory that couples to the host. Additionally or alternatively, the computing device 900 may comprise one or more field programmable gate arrays (FGPAs), application specific integrated circuits (ASIC), or other hardware/software/firmware capable of providing the functionality described herein.

The computing device 900 may include a variety of tangible processor-readable storage media and intangible processor-readable communication signals. Tangible processor-readable storage can be embodied by any available media that can be accessed by the computing device 900 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 900. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

In some aspects, the techniques described herein relate to a system for processing sensor data at a remotely controlled vehicle, including: a plurality of sensors for monitoring an exterior environment of the remotely controlled vehicle to generate a corresponding respective plurality of sensor data feeds, wherein adjacent pairs of the plurality of sensors including an at least partially overlapping field of view; a compositor for combining the plurality of sensor data feeds into a composite data stream; a remote pilot terminal operative to receive the composite data stream and render a representation of the exterior environment of the remotely controlled vehicle to a remote pilot; and a pilot monitor for determining an area of focus of the remote pilot; wherein the area of focus is provided to the compositor for use in differentiating the plurality of data feeds in the composite data stream, and wherein the representation of the exterior environment at the remote operator terminal is based on the area of focus of the remote pilot.

In some aspects, the techniques described herein relate to a system, wherein the plurality of sensors include cameras and the plurality of sensor data feeds include video data feeds.

In some aspects, the techniques described herein relate to a system, wherein the plurality of sensor data feeds of the cameras provide a continuous field of view about at least a portion of the remotely controlled vehicle in the composite data stream.

In some aspects, the techniques described herein relate to a system, wherein the plurality of sensor data feeds of the cameras provide a continuous field of view about an entirety of the remotely controlled vehicle in the composite data stream.

In some aspects, the techniques described herein relate to a system, wherein the compositor is operative to generate the composite data stream such that resolutions of the plurality of sensor data feeds in the composite data stream are based on the area of focus of the remote pilot.

In some aspects, the techniques described herein relate to a system, wherein the area of focus of the remote pilot relative to the exterior environment is identified based on a monitored position of the remote pilot, and wherein the compositor maintains a greater bit rate of first sensor data in the composite data stream for the focus area relative to a lower bit rate for second sensor data away from the area of focus.

In some aspects, the techniques described herein relate to a system, wherein at least one of the plurality of sensors is movable based on the area of focus of the remote pilot.

In some aspects, the techniques described herein relate to a method for processing sensor data at a remotely controlled vehicle, including: determining an area of focus of a remote pilot of the remotely controlled vehicle; monitoring an exterior environment relative to the remotely controlled vehicle with a plurality of sensors to generate a corresponding respective plurality of sensor data feeds, wherein adjacent pairs of the plurality of sensors including an at least partially overlapping field of view; combining the plurality of sensor data feeds into a composite data stream, wherein the composite data stream differentiates the plurality of sensor data feeds in the composite data stream based on the area of focus of the remote pilot; and rendering a representation of the exterior environment at a remote pilot terminal based on the area of focus of the remote pilot.

In some aspects, the techniques described herein relate to a method, wherein the plurality of sensors include cameras and the plurality of sensor data feeds include video data feeds.

In some aspects, the techniques described herein relate to a method, wherein the plurality of sensor data feeds of the cameras provide a continuous field of view about at least a portion of the remotely controlled vehicle in the composite data stream.

In some aspects, the techniques described herein relate to a method, wherein the plurality of sensor data feeds of the cameras provide a continuous field of view about an entirety of the remotely controlled vehicle in the composite data stream.

In some aspects, the techniques described herein relate to a method, further including: generating the composite data stream such that resolutions of the plurality of sensor data feeds in the composite data stream are based on the area of focus of the remote pilot.

In some aspects, the techniques described herein relate to a method, further including: identifying the area of focus of the remote pilot relative to the exterior environment based on a monitored position of the remote pilot; and maintaining a greater bit rate of first sensor data in the composite data stream for the focus area relative to a lower bit rate for second sensor data away from the area of focus.

In some aspects, the techniques described herein relate to a method, further including: moving at least one of the plurality of sensors based on the area of focus of the remote pilot.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A system for processing sensor data at a remotely controlled vehicle, comprising:
a plurality of sensors for monitoring an exterior environment of the remotely controlled vehicle to generate a corresponding respective plurality of sensor data feeds, wherein adjacent pairs of the plurality of sensors comprising an at least partially overlapping field of view;
a compositor for combining the plurality of sensor data feeds into a composite data stream;
a remote pilot terminal operative to receive the composite data stream and render a representation of the exterior environment of the remotely controlled vehicle to a remote pilot; and
a pilot monitor for determining an area of focus of the remote pilot;
wherein the area of focus is provided to the compositor for use in differentiating the plurality of data feeds in the composite data stream, and wherein the representation of the exterior environment at the remote operator terminal is based on the area of focus of the remote pilot.

2. The system of claim 1, wherein the plurality of sensors comprise cameras and the plurality of sensor data feeds comprise video data feeds.

3. The system of claim 2, wherein the plurality of sensor data feeds of the cameras provide a continuous field of view about at least a portion of the remotely controlled vehicle in the composite data stream.

4. The system of claim 3, wherein the plurality of sensor data feeds of the cameras provide a continuous field of view about an entirety of the remotely controlled vehicle in the composite data stream.

5. The system of claim 2, wherein the compositor is operative to generate the composite data stream such that resolutions of the plurality of sensor data feeds in the composite data stream are based on the area of focus of the remote pilot.

6. The system of claim 5, wherein the area of focus of the remote pilot relative to the exterior environment is identified based on a monitored position of the remote pilot, and wherein the compositor maintains a greater bit rate of first sensor data in the composite data stream for the focus area relative to a lower bit rate for second sensor data away from the area of focus.

7. The system of claim 1, wherein at least one of the plurality of sensors is movable based on the area of focus of the remote pilot.

8. A method for processing sensor data at a remotely controlled vehicle, comprising:
determining an area of focus of a remote pilot of the remotely controlled vehicle;
monitoring an exterior environment relative to the remotely controlled vehicle with a plurality of sensors to generate a corresponding respective plurality of sensor data feeds, wherein adjacent pairs of the plurality of sensors comprising an at least partially overlapping field of view;
combining the plurality of sensor data feeds into a composite data stream, wherein the composite data stream differentiates the plurality of sensor data feeds in the composite data stream based on the area of focus of the remote pilot; and
rendering a representation of the exterior environment at a remote pilot terminal based on the area of focus of the remote pilot.

9. The method of claim 8, wherein the plurality of sensors comprise cameras and the plurality of sensor data feeds comprise video data feeds.

10. The method of claim 9, wherein the plurality of sensor data feeds of the cameras provide a continuous field of view about at least a portion of the remotely controlled vehicle in the composite data stream.

11. The method of claim 10, wherein the plurality of sensor data feeds of the cameras provide a continuous field of view about an entirety of the remotely controlled vehicle in the composite data stream.

12. The method of claim 9, further comprising:
generating the composite data stream such that resolutions of the plurality of sensor data feeds in the composite data stream are based on the area of focus of the remote pilot.

13. The method of claim 12, further comprising:
identifying the area of focus of the remote pilot relative to the exterior environment based on a monitored position of the remote pilot; and
maintaining a greater bit rate of first sensor data in the composite data stream for the focus area relative to a lower bit rate for second sensor data away from the area of focus.

14. The method of claim 8, further comprising:
moving at least one of the plurality of sensors based on the area of focus of the remote pilot.
